(19) United States
(12) Patent Application Publication
(10) Pub. No.: US 2005/0089825 A1
(43) Pub. Date: Apr. 28, 2005

(54) System for educating, study assistance and/or training of computer users

(76) Inventor: Ralph Zulferino, Marlboro, NJ (US)

Correspondence Address: Charles I. Brodsky, 2 Bucks Lane, Marlboro, NJ, 07746, US

(21) Appl. No.: 10/958,703

(22) Filed: Oct. 6, 2004

Related U.S. Application Data
(60) Provisional application No. 60/513,616, filed on Oct. 23, 2003.

(51) Int. Cl. G09B 19/00; G09B 3/00

(52) U.S. Cl. 434/118; 434/307 R

(57) ABSTRACT

Access to a computer system is forestalled in the education, study assistance and/or training of computer users until such time as the user has been put through a series of questions/problems pertinent to the user, it being understood that the user must interact with the system in order to first progress the session along toward completion before access to the general computing environment can be had.

### CROSS-REFERENCE TO RELATED APPLICATIONS

A Provisional Application describing this invention was filed Oct. 23, 2003 and assigned Ser. No. 60/513,616.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

Not applicable.

### BACKGROUND OF THE INVENTION

1. Field of the Invention

This invention relates to the education, study assistance and/or training of computer users.

2. Description of the Related Art

It is well known that the personal computer is the fastest growing means of communication, learning, information access and storage and entertainment in today's society. With most homes and businesses having at least one personal computer hooked up to the Internet, both adults and children are finding the computer indispensable in their daily lives.

Along these lines, it has now become important for parents and employers to monitor what their children/employees do on the computer and where they go on the Internet. It is also important for parents to commence controlling that use, from the point of view of monitoring the amount of time a child is on the computer. For example, before personal computers, parents mostly had to concern themselves with how much television a child watched. Now, however, a child not only has television, but the computer and the Internet to distract him/her from things such as school and homework.

### OBJECTS OF THE INVENTION

Accordingly, it is a primary goal of the present invention to create a system to be used on a home or office personal computer to help educate and/or train the user, and/or to act as a study assistant during normal computer access time.

It is also an object of the present invention to be used as a study guide to help students remember vocabulary words, math concepts and other tested principles preparing for SAT, ACT, LSAT, GMAT, etc. and any other standardized test.

It is also an object of the present invention to incorporate the education of children, adults and employees of jobs through various different embodiments.

### SUMMARY OF THE INVENTION

The system comprises software that is installed upon a computer which restricts access to the computer (and therefore the Internet) until the user completes tutorial/study material for certain time limit/or percentage achieved. In its most fundamental form, once the prospective user of the computer spends a certain amount of time (which will be set by parent, teacher or employer and/or answers a certain percentage of the questions correctly) access will be granted to the full range of activities available on the computer.

### BRIEF DESCRIPTION OF THE DRAWINGS

These and other features of the present invention will be more clearly understood from a consideration of the following description, taken in connection with the accompanying drawings, in which:

FIGS. 1-3 are flow charts helpful in an understanding in the educational, study and/or training aspects of the invention.

### DETAILED DESCRIPTION OF THE INVENTION

After installing the system on their computer, parent, teacher or employer will need to set up user names and passwords for all computer users. Every time the computer is turned on it will request the user name and password. Certain user names and/or passwords will activate the tutorial section (such as the child's information), but other user names and passwords will bypass the tutorials (such as the parents information). Once activated by the entry of the child's user name and password, the computer will not immediately open up (access to computer, games, internet denied) onto the normal homepage for the child or employee, but will go into tutorial/study material, thereby forcing the user to interact with the system before regular access is granted. The system will be arranged pursuant to the parent's/teacher's/employer's earlier requirements (length of time of sessions/and or how many areas or questions will be run) before being allowed access to the unrestricted access to the computer/Internet.

The invention also anticipates that not only will the parent/teacher/employer be able to determine length of each session, but the invention also anticipates the parent/teacher/employer being able to determine the following types of parameters and information: (1) the percentage of correct answers needed to obtain access to the child's or employee's normal computer homepage and usage (if being used as an educational tool//on the job training tool); (2) whether, once on the computer, to give the person unlimited access, or to run additional tutorials every 5, 10, 20 or 30 minutes, or some other amount of time (logging the user off the computer and running another set of questions); (3) time limit if student or employee-does not achieve percentage correct (which can change), but in this case repeat sessions based on percentage correct, until move on to next level; and (4) the parent/teacher/employer will be able to determine the types of subject matter questions to be presented, whether they be math, reading comprehension, English or other topics.

In the embodiment of point (2) above, it is anticipated that the second, third, etc. sets of tutorials can be questions similar in subject matter type to the previous set(s), or can change to different academic areas. It is also anticipated in this regard that the second, third, etc. sets of tutorials can have different success requirements (number of questions and/or percentage correct) than were previously given in the earlier set(s).

The questions would normally be asked in a multiple choice setting, allowing a child to choose from, for example, answers A-D. As an example, the system might be geared for vocabulary and ask the child what is the meaning of the word “superfluous.” The system would then give the child a choice of different definitions and the child would have to pick the one that he/she things is correct. Another way of asking the same type of question would be to give a definition of a word and then ask the child to pick the word corresponding to the given definition.

As indicated above, instead of being a tutorial-type system, the invention can be used as a study guide where it is not based on achievement but rather on time limits and repetition of sessions. As an example, let's say a parent is not seeing a child do enough studying for the SAT or ACT exam for entrance into college. The parent would purchase an embodiment of the system of the subject invention directed to SAT studying. For example, the vocabulary section would give a word, maybe even a picture to help with association between the word, its meaning, give the definition, maybe words that are similar and dissimilar. It may give a sample sentence with the word in it. It can also be used to study for the math, and reading comprehension sections or any other tested principles, by utilizing actual SAT type problems and solutions. When being used as a study guide the sessions will be set by time limits per session, also the parent will be able to decide how many times in a day (if child logs off and back on) the session will be repeated and the amount of days the same session will be given (3 days, 5 days, etc.) before moving onto next (different) session. It is important to note that students will need to actually interact with the system to get through the session and will not be able to just let the tutorial run.

As has been previously stated, other manners of educational subject matter are fully anticipated by the invention. For example, it is fully anticipated that the system could also be simply directed to standard everyday school topics to assist students in advancing their regular academic achievement. In this regard, the system would be purchased pursuant to a particular grade category of learning (for example, any of the standard grade levels of any educational system from elementary school through high school and even into college and graduate school). Here again, a parent would be able to choose amongst the topics that are appropriate for the grade level and so the system chosen could simply be reading words or letter identification for the younger grades, or advanced math problems and/or essay reading questions and/or geography questions for the higher grade levels. No topic is meant to be excluded that is normally involved in a public educational system, and so tutorials for anything from advanced sciences to physical education are anticipated by the invention.

Other embodiments of the invention include employers being able to purchase the system for tutorial education of their employees. In this regard, it is anticipated that employers would be able to purchase tutorial software that is geared towards their business and the types of information their employees should regularly know. Examples might be in law firms and/or accounting firms. Even in these specialized areas there are sub-specialties. Therefore, in a law firm environment if the firm deals only with a specific kind of law, as, for example, intellectual property, maritime, family law, corporate law, etc., the employer could purchase the system specific to the specialized area. The system could even be as advanced as to have the particular laws of the particular State where the firm is located. For example, estate planning laws are different throughout the fifty States.

Yet another embodiment of the invention would be to simply advance a computer user's knowledge of certain areas of interest, such as, cooking, arts and crafts, art history, landscaping and gardening, home improvement, and any other aspect of modern day life that is imaginable. The basic concept of the invention being to forestall Q access to a computer system until such time as the perspective user has been put through a series of questions/problems that is pertinent to the user. It being understood that the user must interact with the system in order to progress the session; the session will not advance toward completion without this interaction.

The system also anticipates including software that will allow the tutorial to be overwritten by the parent or employer, should the need arise. The override would consist of the ability of the parent/employer to totally disconnect from the system so that computer access is freely available, to changing the number of questions presented and/or session time lengths and/or the percentage of correct answers required at any time during the tutorial if it is seen by the parent/employer that too much is being asked of the child/employee.

It is also anticipated that the system of the subject invention could be accessible over a remote server. For example, instead of having to install the full software on the person's personal computer and/or have a CD with the information running in a drive of the computer, the simple downloading of communication software to allow a connection to a central server containing all of the various types of tutorials, is also anticipated. In this regard, a person could simply go to the appropriate website on the Internet and set up his/her own account for their computers, including setting up different user names and passwords, each having their own tutorial criteria pursuant to any of the above discussed embodiments.

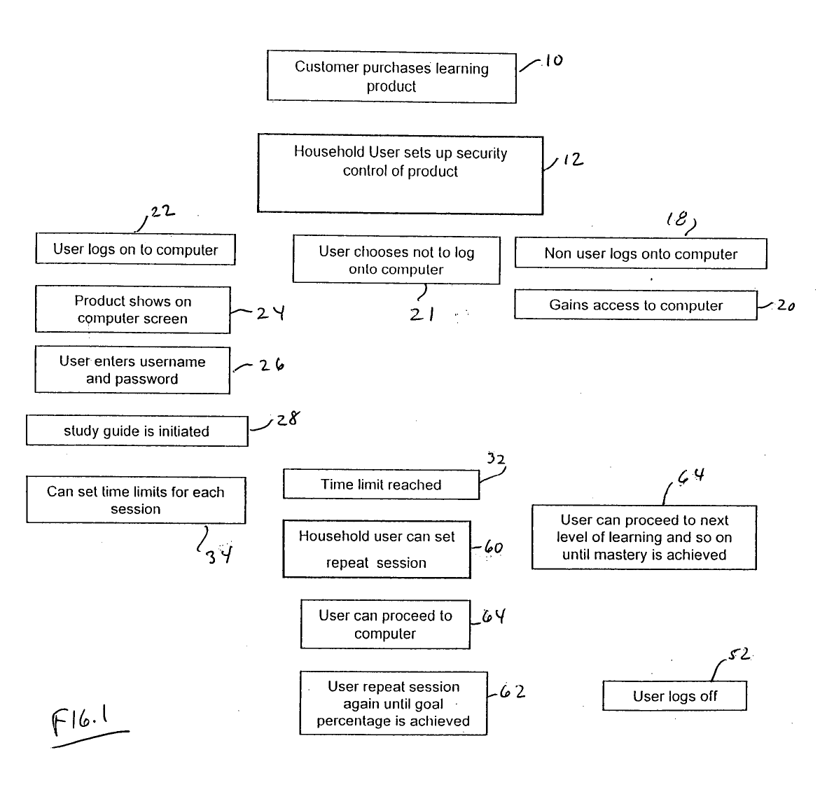

Attention is directed to the FIGS. 1-3 which illustrate flow charts helpful in an understanding of the working of the system and the method of the invention.

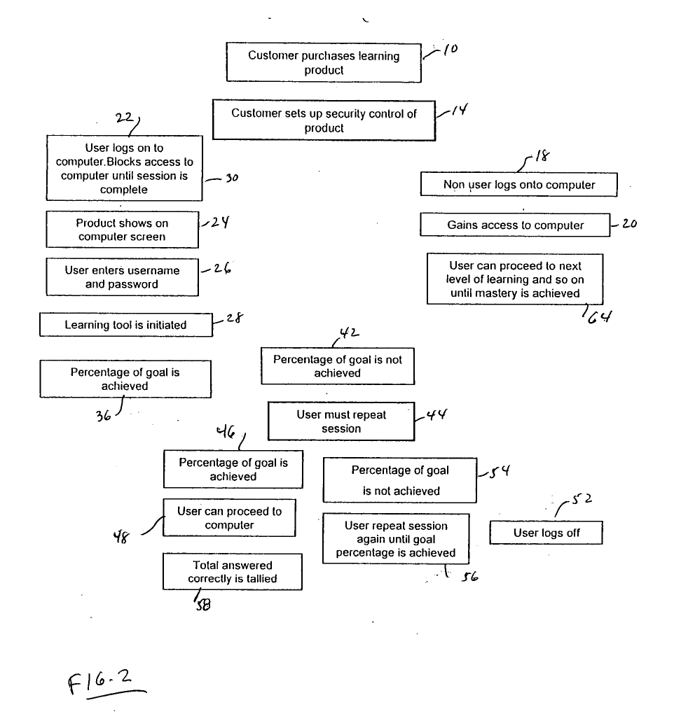

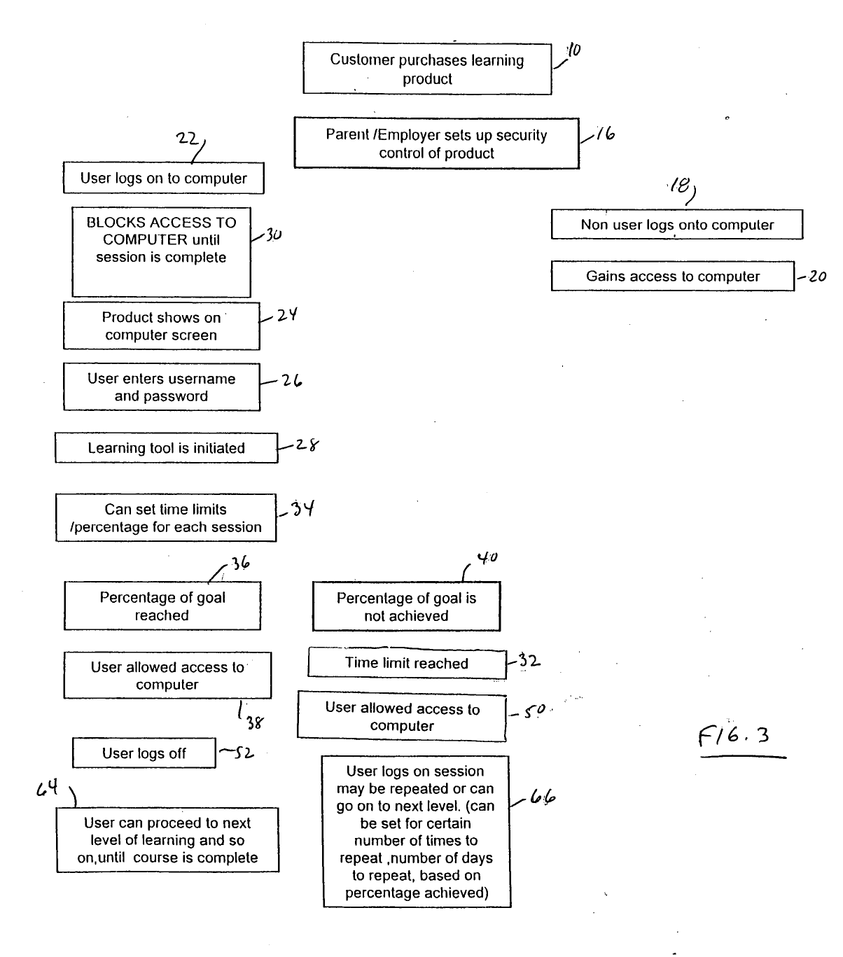

In the FIGS. 1-3, the customer purchases the learning product at 10 for inputting into the computer its software from a disk or by downloading from a remote central server, and establishes the appropriate security control either by a household user (12 in FIG. 1), a customer (14 in FIG. 2) or a parent/employer (16 in FIG. 3). Non-users of the learning product log on to the computer at 18, and gain access to its general computing environment at 20. To use the training or study tutorial, the user logs onto the computer at 22, the product shows on the computer screen as at 24 and the user enters his/her name and/or password, as at 26. The learning tool or study guide is initiated as at 28 and the software of the tutorial/study guide operates to block access to the general computing environment until the tutorial/study/training session is completed (30). The user may also choose not to log onto the computer, as at 21.

As previously mentioned, the inputted software may be set to block the general computer environment access until user interaction with the program has proceeded for a predetermined time interval (32). Overrides could be provided to the household user, the parent or employer to vary such time limit, however (34). Alternatively, the software may be established to continue to block access to the general computing environment until the user has interacted with the learning product to provide a predetermined percentage of correct question answering or problem solving which, when attained (as at 36), then disables the access block to allow the user general entry to the computer, as at 38 (FIG. 3). Where the percentage of correct answers is not achieved (40 in FIG. 3, 42 in FIG. 2), the session is repeated (as at 44 in FIG. 2), until the percentage of correct question answering/problem solving is attained (46 in FIG. 2), at which time the user can again proceed to the computer as the access block is then disabled (48 in FIG. 2, 50 in FIG. 3). Eventually, the user logs off the computer, as at 52 in each of FIGS. 1-3. As FIG. 2 indicates, if the percentage of correct question answering/problem solving still has not been attained (as at 54), the session is repeated again until the percentage is achieved (as at 56). At such instance, the access block is disabled and the user can proceed to the computer home page, its stored games, the Internet, etc. in the various computer multi-task operations. As FIG. 2 indicates, rather than disabling the access block once a percentage of correct answers and solutions are provided, the block could be disabled once the user interaction provides a predetermined correct number of answers/solutions, as at 58. As before where the time limit for the interactive processing by the user can be overridden from that set by the software at 34, so, too, can the percentage of correct answers/solutions be determined there as well, as can the lengths of time for each repeat session until the goal is achieved, as at 60, 62 before the user can proceed to the computer with the disabling of the access block as at 64.

As will be appreciated by those skilled in the art, rather than disabling the access block at such time, the block may be continued, or if once disabled, could be enabled once more in allowing the user to proceed to the next level of learning, continuing in the same manner, until master of the tutorial study is achieved. Operating in substantially the same way for intervals of time, for percentage of correct question answers/problem solving or for numbers of such answers or solutions, these features are indicated as at 64 in each of FIGS. 1-3 with the controls then being established for this advanced teaching/training as at 66 in FIG. 3.

While there have been described what are considered to be preferred embodiments of the invention, it will be readily appreciated by those skilled in the art that modifications can be without departing from the scope of the teachings herein of locking out access to a user's computer until after he/she has interacted with it in a prescribed manner for either one or both of a prescribed interval of time or until a predetermined degree of proficiency in the study tutorial has been achieved. For at least such reason, therefore, resort should be had to the claims appended hereto for a true understanding of the scope of the invention.

1. A method for educating, providing study assistance to, and or training computer users comprising the steps of:
first, inputting software into a computer containing material to be taught and/or studied by a user thereof; and
second, blocking access to the general computer environment of the computer until the user has interacted with the software for at least one of a predetermined interval of time and a predetermined manner of correct question answering/problem solving in disabling the access block.

2. The method of claim 1, wherein said second, access blocking step is actuated upon entry of a preselected user name and/or password.

3. The method of claim 1, wherein said access block, once disabled, is enabled a preselected time interval later.

4. The method of claim 3, wherein said access block, once disabled, is enabled a preselected time interval later until further interaction by the user for at least one of a second, predetermined interval and a second, predetermined manner of correct question answering/problem solving in further disabling the enabled access block.

5. The method of claim 1, wherein said second, access blocking step continues until the user has interacted with the software for a predetermined percentage of correct question answering/problem solving situations.

6. The method of claim 1, wherein said second, access blocking step continues until the user has interacted with the software for a predetermined number of correct question answering/problem solving situations.

7. The method of claim 1, wherein said second, access blocking step blocks access to said general computing environment until the user interacts with the software in a predetermined manner of correct question answering/problem solving situation asked in multiple choice format form.

8. The method of claim 1, wherein said first step inputs software encoded upon a software disk.

9. The method of claim 1, wherein said first step inputs software downloaded from a remote central server.

10. The method of claim 1, wherein said inputted software controls the time interval of user interaction, the number of correct question answering/problem solving situations, and the percentage of correct question answering/problem solving situations before disabling said access block, and wherein there is also included a third step of overriding said software control for changing at least one of said time intervals, percentages of correct question answering/problem solving situations and numbers of correct question answering/problem solving situations before disabling said block.
